(19) United States
(12) Patent Application Publication
(10) Pub. No.: US 2008/0104414 A1
(43) Pub. Date: May 1, 2008

(54) Apparatus And Method For Decryption, Electronic Apparatus And Method For Inputting Password Encryption, And Electronic System With A Password

(75) Inventors: Wesley Cheng, Hsinchu (TW); Chien-Cheng Lin, Hsinchu County (TW); Dallas T. Johnston, Austin, TX (US)

Correspondence Address: GROSSMAN, TUCKER, PERREAULT & PFLEGER, PLLC, 55 SOUTH COMMERICAL STREET, MANCHESTER, NH, 03101, US

(73) Assignee: SILICON MOTION, INC., Hsinchu County (TW)

(21) Appl. No.: 11/680,875

(22) Filed: Mar. 1, 2007

(30) Foreign Application Priority Data
Oct. 30, 2006 (TW) 095140023

(51) Int. Cl. H04L 9/00

(52) U.S. Cl. 713/186

(57) ABSTRACT

Electronic apparatus and method for decryption, electronic apparatus and method for inputting password encryption, and system comprising said apparatuses are provided. The electronic apparatus comprises a detection unit, a generation unit, and a decryption unit. The detection unit is configured to detect a biological feature. The generation unit is configured to generate a key and a copied key according to the biological feature. The decryption unit is configured to decrypt an encrypted text by a decryption algorithm according to the key to get an input password. The input password is used to decide whether the electronic apparatus can be operated or not. The apparatus for inputting password encryption encrypts the input password by the copied key. The methods are executed to achieve functions of the aforementioned apparatuses.

This application claims priority to Taiwan Patent Application No. 095140023 filed on Oct. 30, 2006, the disclosures of which are incorporated herein by reference in its entirety.

### CROSS-REFERENCES TO RELATED APPLICATIONS

Not applicable.

### BACKGROUND OF THE INVENTION

1. Field of the Invention

The present invention relates to a system, an apparatus and a method of encryption and decryption. More particularly, the present invention relates to a system, an apparatus, and a method for generating a key by using a biological feature to encrypt and decrypt an input password.

2. Descriptions of the Related Art

With a rapid development of information technologies and computer industries, there are more and more digital stored data and meanwhile, sizes of storage mediums become smaller and smaller. Consequently, many users store data in portable storage mediums, such as a flash disk, for the convenience. To secure data, a storage medium is usually divided into a public area and a security area. A user may store the data to be secured in the security area. When the user intends to access the data stored in the security area, an identity authentication is required. After the identity has been authenticated, the information in the security area can be accessed.

A conventional identity authentication method is to use a password, that is, the user sets a password in a memory in advance, afterward, a processor of a computer compares whether an inputted password from the user is equal to the password. However, when the processor retrieves the password for comparison, the password is easily to be obtained by other people via internet or other collateral access ways. Consequently, how to provide a securer platform to protect the password and the inputted password is very important.

One of the solutions is to adopt techniques of the cryptography. The password of the user is encrypted and then stored in the memory by an authentication system. By adopting this method, if the password is stolen, only some meaningless random code but not the password will be obtained. FIG. 1 depicts an authentication system 1, which comprises an encryption apparatus 11 and a decryption apparatus 12. The encryption apparatus 11 utilizes an encryption key 131 to encrypt an original data 101, i.e. the password, by an encryption algorithm to get an encrypted data 102. The decryption apparatus 12 utilizes a decryption key 132 to decrypt the encrypted data 102 by a decryption algorithm to get a decrypted data 103. The decrypted data 103 that has been correctly decrypted is the original data 101.

According to the contents of the encryption key and the decryption key, the authentication systems can be classified into symmetric (or called as a secret key) authentication systems and asymmetric (or called as a public key) authentication systems. The encryption key and the decryption key of a symmetric authentication system are the same, which has the advantage of high efficiency. However, its difficulty is how to transmit the secret key to a receiver in a secure manner. On the other hand, the encryption key and the decryption key of the asymmetric password system are different so that the problem of transmitting the key can be avoided. However, the algorithm of the asymmetric authentication system is more complicated and results in longer processing time. Thus, most authentication systems do not adopt the asymmetric one.

Consequently, how to utilize the symmetric password system to protect the stored data in the storage apparatus and to avoid the risk of obtaining the key by others during transmitting is still a topic worth to study.

### SUMMARY OF THE INVENTION

An object of this invention is to provide an electronic apparatus for decryption. The electronic apparatus comprises a detection unit, a generation unit, and a decryption unit. The detection unit is configured to randomly detect a biological feature. The generation unit is configured to generate a key and a duplicate key according to the biological feature. The decryption unit is configured to decrypt an encrypted text by a decryption algorithm and the key to derive an input password. The encrypted text is encrypted by an encryption algorithm corresponding to the decryption algorithm and the duplicate key of the key. The input password is used to determine whether the electronic apparatus can be operated.

Another object of this invention is to provide an electronic apparatus for encrypting an input password. The electronic apparatus comprises a receiving unit, a decryption unit, an encryption unit, and a transmission unit. The receiving unit is configured to receive an encrypted duplicate key. The decryption unit is configured to decrypt the encrypted duplicate key to derive a duplicate key. The encryption unit is configured to encrypt the input password by an encryption algorithm and the duplicate key to derive an encrypted text. The transmission unit is configured to transmit the encrypted text. The duplicate key is essentially equivalent to a key, the key is derived according to a biological feature. The input password is used to determine whether an electronic device can be operated.

Yet another object of this invention is to provide an electronic system setting a password. The electronic system comprises an electronic apparatus and a password processing apparatus. The electronic apparatus comprises a detection unit, a generation unit, a second original key, and a decryption unit. The detection unit is configured to randomly detect a biological feature. The generation unit is configured to generate a key and a duplicate key according to the biological feature. The second original key is used for encrypting the duplicate key to drive an encrypted duplicate key. The decryption unit is configured to decrypt an encrypted text by a decryption algorithm and the key to derive an input password. The password processing apparatus is configured to encrypt the input password, comprising a first receiving unit, a first decryption unit, a first encryption unit, and a first transmission unit. The first receiving unit is configured to receive the encrypted duplicate key. The first decryption unit is configured to decrypt the encrypted duplicate key. The first encryption unit is configured to encrypt the input password by the duplicate key and an encryption algorithm corresponding to the decryption algorithm to derive the encrypted text. The first transmission unit is configured to transmit the encrypted text to the electronic apparatus. The input password is used to determine whether the electronic apparatus can be operated.

A further object of this invention is to provide a method for decryption, which is adapted to an electronic apparatus that has been set a password. The method comprises the steps of: detecting a biological feature randomly; generating a key and a duplicate key according to the biological feature; and decrypting an encrypted text by a decryption algorithm and the key to derive an input password. The encrypted text is encrypted by an encryption algorithm corresponding to the decryption algorithm and the duplicate key of the key and the input password is used to determine whether the electronic apparatus can be operated.

Yet a further object of this invention is to provide a method for encrypting an input password. The method comprises the following steps of: receiving an encrypted duplicate key; decrypting the encrypted duplicate key to derive a duplicate key; encrypting the input password by an encryption algorithm and the duplicate key to derive an encrypted text; and transmitting the encrypted text. The duplicate key is essentially equivalent to a key, the key is derived according to a biological feature. The input password is used to determine whether an electronic device can be operated.

This invention utilizes a biological feature to generate a key to provide the key dynamically. In other words, when the inputted biological feature is different, different keys are generated. Meanwhile, this invention utilizes the key to encrypt an input password. Consequently, security threats caused by transmitting the key and the input password can be avoided by this invention.

The detailed technology and preferred embodiments implemented for the subject invention are described in the following paragraphs accompanying the appended drawings for people skilled in the art to well appreciate the features of the claimed invention.

### BRIEF DESCRIPTION OF THE DRAWINGS

FIG. 1 illustrates a schematic authentication system;

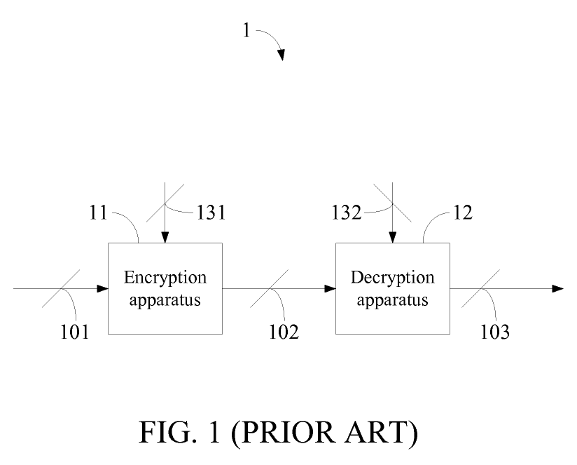

FIG. 2 illustrates a first embodiment of this invention;

FIG. 3 illustrates a second embodiment of this invention; and

FIG. 4 illustrates a third embodiment of this invention.

### DESCRIPTION OF THE PREFERRED EMBODIMENT

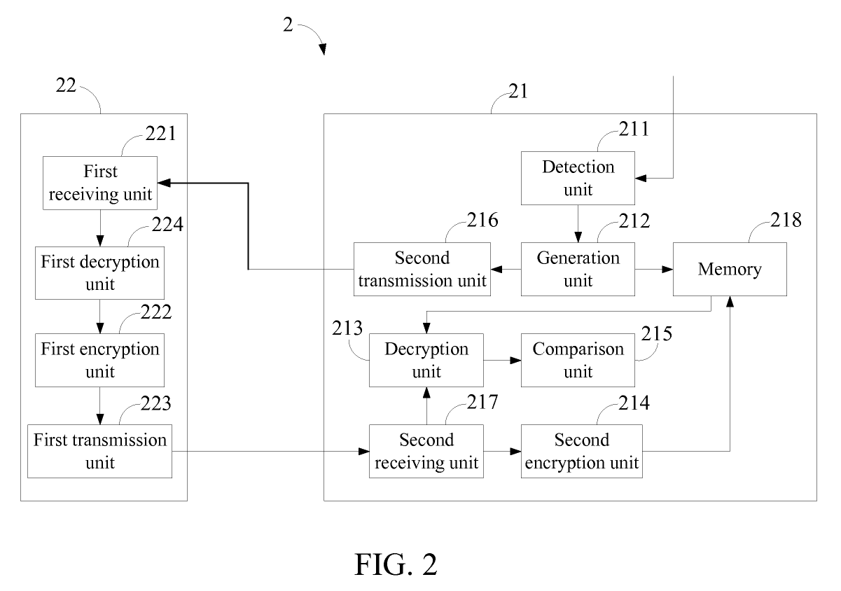

FIG. 2 illustrates a first embodiment of this invention, which is an electronic system 2 having been set with a password. The electronic system 2 comprises an electronic apparatus and a password processing apparatus. The electronic apparatus of this embodiment is a USB disk 21, the password processing apparatus is a personal computer 22 which encrypts and decrypts by a Twofish encryption and decryption algorithm at the same time. The USB disk 21 comprises a detection unit 211, a generation unit 212, a decryption unit 213, a second encryption unit 214, a comparison unit 215, a second transmission unit 216, a second receiving unit 217, and a memory 218. The personal computer 22 comprises a first receiving unit 221, a first encryption unit 222, a first transmission unit 223, and a first decryption unit 224.

When the USB disk 21 is just manufactured, it has not been set with a password, but it has an original key and a second original key. Meanwhile, the personal computer 22 comprises a second duplicate key, which is substantially equivalent to the second original key. When a user intends to set a password to the USB disk 21, the USB disk 21 will be connected to the personal computer 22 first and then the password is keyed in through the personal computer 22. The first transmission unit 223 of the personal computer 22 transmits the password to the USB disk 21 and the second receiving unit 217 of the USB disk 21 receives the password. And then, the second encryption unit 214 encrypts the password by the original key and the Twofish encryption algorithm to generate an original encrypted text. The original encrypted text is stored in the memory 218. Therefore, the user accomplishes the password setting of the USB disk 21.

Afterward, once the user intends to use the USB disk 21, an authentication of the password is required. At first, the user connects the USB disk 21 to the personal computer 22. Next, the detection unit 211 detects a biological feature, which is a fingerprint in this embodiment. Next, the generation unit 212 generates a key and a duplicate key according to the fingerprint. The key is stored in the memory 218, and the duplicate key after encrypted by the second original key is transmitted to the personal computer 22 via the second transmission unit 216. The personal computer 22 receives the encrypted duplicate key via the first receiving unit 221. Next, the first decryption unit 224 derives the duplicate key by using the second duplicate key to decrypt the encrypted duplicate key. And then, the user enters an input password in the personal computer 22. The first encryption unit 222 encrypts the input password by using the duplicate key via a Twofish encryption algorithm to derive the encrypted text. The first transmission unit 223 transmits the encrypted text to the USB disk 21 and the second receiving unit 217 receives the encrypted text.

Next, the decryption unit 213 decrypts the encrypted text by the key stored in the memory 218 via the Twofish decryption algorithm to derive the input password. The decryption unit 213 also decrypts the original encrypted text by the original key stored in the memory 218 via the Twofish decryption algorithm to derive the password. Next, the comparison unit 215 compares the input password and the password, if the input password is equal to the password, the USB disk 21 can be operated.

It has to be emphasized that the Twofish encryption algorithm and the Twofish decryption algorithm of the first embodiment correspond to each other. That is, the encrypted text encrypted by the Twofish encryption algorithm can also be decrypted by the Twofish decryption algorithm. The Twofish encryption and decryption algorithm can be substituted by other symmetric encryption and decryption algorithms which are adapted to an advanced encryption standard, such as encryption and decryption algorithms of MARS, RC6, RIJNDALE, and SERPENT, etc.

Furthermore, the fingerprint of the first embodiment can also be substituted by one of an iris, a voice frequency, other biological features, and a combination thereof. Since the detection unit 211 detects the biological feature randomly, the probability that detecting results of different times being the same is very low. By the randomness, the problem that duplicate key being stolen can be avoided. Meanwhile, encrypting the input password by the key can reduce security hazard caused by transmitting the input password.

The USB disk 21 of the first embodiment can be substituted by other electronic apparatuses, while the personal computer 22 can also be substituted by other processing apparatuses capable of calculations. The electronic apparatus and the password processing apparatus can exist independently. The only requirement is that the encryption algorithm and the decryption algorithm comprised in the electronic apparatus and the password processing apparatus correspond to each other.

With the aforementioned configurations, the first embodiment is able to provide the key to the user dynamically to avoid the security threat caused by re-using the same key.

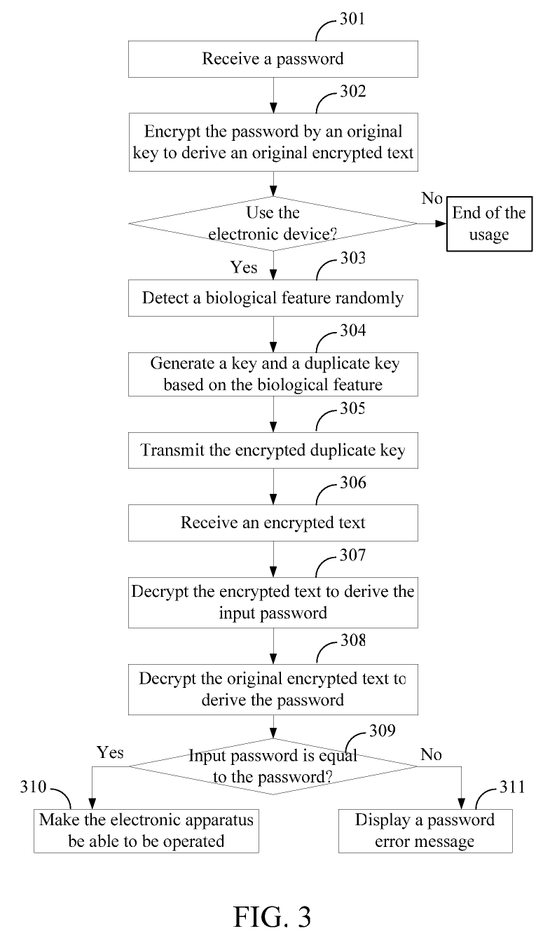

FIG. 3 illustrates a second embodiment of this invention, which is a flow chart comprising a decryption method. The method is suitable for an electronic apparatus. The method is mainly divided into two parts, which is a setting password part and a decryption part, respectively.

Step 301 is executed first to receive a password which is the password of the electronic apparatus. Next, step 302 is executed to encrypt the password by an original key to derive an original encrypted text, wherein the original encrypted text is stored in the electronic apparatus. Step 301 and step 302 accomplish the setting password part of the method.

After setting the password, if the user intends to use the electronic apparatus, step 303 is executed to detect a biological feature randomly. Next, step 304 is executed to generate a key and a duplicate key based on the biological feature, wherein the key is stored in the electronic apparatus and the duplicate key is encrypted by a second original key. Step 305 is executed next to transmit the encrypted duplicate key. After a period of time, step 306 is executed to receive an encrypted text, wherein the encrypted text is derived by an encryption algorithm using the duplicate key to encrypt an input password. Next, step 307 is executed to decrypt the encrypted text by a decryption algorithm and the key to derive the input password, and step 308 is executed to decrypt the original encrypted text by the decryption algorithm using the original key to derive the password. Next, step 309 is executed to determine whether the input password is equal to the password. If yes, step 310 is executed to make the electronic apparatus be able to be operated; if not, step 311 is executed to display a password error message. To be explained here is that if the encryption algorithm and the decryption algorithm of the encrypted text received by step 306 are not symmetric, the correct result cannot be obtained. That is, after step 307 is executed, the encrypted text cannot be decrypted, and the comparison result of step 309 shows non-equivalent between the input password and the password.

After setting the password, once the user intends to use the electronic apparatus, repeat only step 303 to step 311 is enough. In addition to the aforementioned steps, the second embodiment is able to execute all the aforementioned operations and functions of the USB disk 21 of the first embodiment.

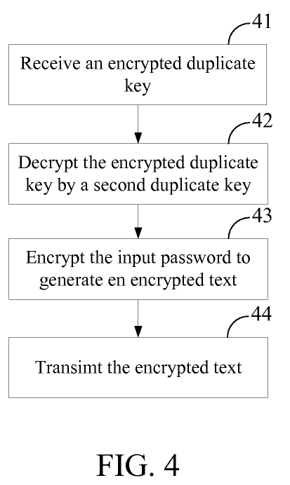

FIG. 4 depicts a third embodiment of this invention, which is a flow chart of a method of protecting an input password. First, step 41 is executed to receive an encrypted duplicate key, wherein the encrypted duplicate key is the encrypted duplicate key transmitted in step 305 of the second embodiment. Next, step 42 is executed to decrypt the encrypted duplicate key by a second duplicate key. Next, step 43 is executed to encrypt the input password by the duplicate key via an encryption algorithm to generate en encrypted text. Finally, step 44 is executed to transmit the encrypted text which is identical to the encrypted text received in step 306 of the second embodiment. Except the aforementioned steps, the third embodiment can further execute all the described operations or functions of the personal computer 22 of the first embodiment.

With the aforementioned embodiments, it is able to understand that the present invention provides a key dynamically. That is, the key is generated by a randomly detected biological feature. With the randomly generated key to execute the encryption function of the input password, the security leakage caused by the key and the input password been stolen is avoided.

The above disclosure is related to the detailed technical contents and inventive features thereof. People skilled in the art may proceed with a variety of modifications and replacements based on the disclosures and suggestions of the invention as described without departing from the characteristics thereof. For instance, it is also applicable that the user can key in an input password to the personal computer first, after the first encryption unit receives the duplicate key, the encryption algorithm is used to encrypt the input password to derive the encrypted text. Nevertheless, although such modifications and replacements are not fully disclosed in the above descriptions, they have substantially been covered in the following claims as appended.

What is claimed is:

1. An electronic apparatus for decryption, comprising:
a detection unit for randomly detecting a biological feature;
a generation unit for generating a key and a duplicate key according to the biological feature; and
a decryption unit for decrypting an encrypted text by a decryption algorithm and the key to derive an input password;
wherein the encrypted text is encrypted by an encryption algorithm corresponding to the decryption algorithm and the duplicate key of the key and the input password is used to determine whether the electronic apparatus can be operated.

2. The electronic apparatus of claim 1, further comprising:
an encryption unit for encrypting a password by the encryption algorithm and an original key to derive an original encrypted text and for encrypting the duplicate key by a second original key; and
a comparison unit for comparing the input password and the password;
wherein the decryption unit is further configured to decrypt the original encrypted text by the decryption algorithm and the original key to derive the password, and the electronic apparatus can be operated if the input password is equivalent to the password.

3. The electronic apparatus of claim 2, further comprising a transmission unit for transmitting the encrypted duplicate key.

4. The electronic apparatus of claim 3, further comprising a receiving unit for receiving the encrypted text.

5. The electronic apparatus of claim 1, wherein the biological feature is one of a fingerprint, an iris, and a voice frequency or a combination thereof.

6. The electronic apparatus of claim 1, wherein the encryption algorithm is a symmetric encryption algorithm, the decryption algorithm is a symmetric algorithm, and the decryption algorithm corresponds to the encryption algorithm.

7. An electronic apparatus for encrypting an input password, comprising:
a receiving unit for receiving an encrypted duplicate key;
a decryption unit for decrypting the encrypted duplicate key to derive a duplicate key;
an encryption unit for encrypting the input password by an encryption algorithm and the duplicate key to derive an encrypted text; and
a transmission unit for transmitting the encrypted text;
wherein the duplicate key is essentially equivalent to a key, the key is derived according to a biological feature, and the input password is used to determine whether an electronic device can be operated.

8. The electronic apparatus of claim 7, wherein the biological feature is one of a fingerprint, an iris, and a voice frequency or a combination thereof.

9. The electronic apparatus of claim 7, wherein the encryption algorithm is a symmetric encryption algorithm.

10. An electronic system setting a password, comprising:
an electronic apparatus, including:
a detection unit for randomly detecting a biological feature;
a generation unit for generating a key and a duplicate key according to the biological feature;
a second original key for encrypting the duplicate key to drive an encrypted duplicate key; and
a decryption unit for decrypting an encrypted text by a decryption algorithm and the key to derive an input password; and
a password processing apparatus for encrypting the input password, including:
a first receiving unit for receiving the encrypted duplicate key;
a first decryption unit for decrypting the encrypted duplicate key;
a first encryption unit for encrypting the input password by the duplicate key and an encryption algorithm corresponding to the decryption algorithm to derive the encrypted text; and
a first transmission unit for transmitting the encrypted text to the electronic apparatus;
wherein the input password is used to determine whether the electronic apparatus can be operated.

11. The electronic system of claim 10, wherein the electronic apparatus further comprises:
a second encryption unit for encrypting a password by the encryption algorithm and an original key to derive an original encrypted text; and
a comparison unit for comparing the input password and the password;
wherein the decryption unit is further configured to decrypt the original encrypted text by the decryption algorithm and the original key to derive the password, and the electronic apparatus can be operated if the input password is equivalent to the password.

12. The electronic system of claim 10, wherein the electronic apparatus further comprises a second transmission unit for transmitting the encrypted duplicate key.

13. The electronic system of claim 12, wherein the electronic apparatus further comprises a second receiving unit for receiving the encrypted text.

14. The electronic system of claim 10, wherein the biological feature is one of a fingerprint, an iris, and a voice frequency or a combination thereof.

15. The electronic system of claim 10, wherein the encryption algorithm is a symmetric encryption algorithm, the decryption algorithm is a symmetric algorithm, and the decryption algorithm corresponds to the encryption algorithm.

16. A method for decryption, being adapted to an electronic apparatus setting a password, the method comprising the steps of:
detecting a biological feature randomly;
generating a key and a duplicate key according to the biological feature; and
decrypting an encrypted text by a decryption algorithm and the key to derive an input password;
wherein the encrypted text is encrypted by an encryption algorithm corresponding to the decryption algorithm and the duplicate key of the key and the input password is used to determine whether the electronic apparatus can be operated.

17. The method of claim 16, further comprising the steps of:
encrypting the password by the encryption algorithm and an original key to derive an original encrypted text; and
comparing the input password and the password;
wherein the original encrypted text can be decrypted by the decryption algorithm and the original key to derive the password, and the electronic apparatus can be operated if the input password is equivalent to the password.

18. The method of claim 16, further comprising the step of encrypting the duplicate key.

19. The method of claim 16, further comprising the step of transmitting the encrypted duplicate key.

20. The method of claim 19, further comprising the step of receiving the encrypted text.

21. The method of claim 16, wherein the biological feature is one of a fingerprint, an iris, and a voice frequency or a combination thereof.

22. The method of claim 16, wherein the encryption algorithm is a symmetric encryption algorithm, the decryption algorithm is a symmetric algorithm, and the decryption algorithm corresponds to the encryption algorithm.

23. A method for encrypting an input password, comprising the steps of:
receiving an encrypted duplicate key;
decrypting the encrypted duplicate key to derive a duplicate key;
encrypting the input password by an encryption algorithm and the duplicate key to derive an encrypted text; and
transmitting the encrypted text;
wherein the duplicate key is essentially equivalent to a key, the key is derived according to a biological feature, and the input password is used to determine whether an electronic device can be operated.

24. The method of claim 23, wherein the biological feature is one of a fingerprint, an iris, and a voice frequency or a combination thereof.

25. The method of claim 23, wherein the encryption algorithm is a symmetric encryption algorithm.
